(19) United States
(12) Patent Application Publication
(10) Pub. No.: US 2026/0225330 A1
(43) Pub. Date: Aug. 6, 2026

(54) FIBER-REINFORCED RESIN MOLDED BODY, AND MANUFACTURING METHOD THEREFOR

(71) Applicants: MITSUI CHEMICALS, INC., Chuo-ku, Tokyo (JP); ARRK CORPORATION, Osaka-shi, Osaka (JP)

(72) Inventors: Atsumi NISHIDA, Chiba-shi, Chiba (JP); Atsushi MIYATA, Urayasu-shi, Chiba (JP); Kazuya MIZUMOTO, Sodegaura-shi, Chiba (JP); Tomio BANDO, Saitama (JP); Toshinobu ARAI, Saitama (JP)

(73) Assignees: MITSUI CHEMICALS, INC., Chuo-ku, Tokyo (JP); ARRK CORPORATION, Osaka-shi, Osaka (JP)

(21) Appl. No.: 19/155,603

(22) PCT Filed: Feb. 6, 2024
(86) PCT No.: PCT/JP2024/003907

§ 371 Date: Aug. 12, 2025

(30) Foreign Application Priority Data
Feb. 13, 2023 (JP) 2023-020022

(51) Int. Cl. B29C 70/46; B29C 70/20; B29K 105/10

(52) U.S. Cl. CPC B29C 70/46; B29C 70/20; B29K 2105/10

(57) ABSTRACT

Provided is a fiber-reinforced resin molded body that allows for the formation of a rib portion that is composed of the fiber-reinforced resin and has a predetermined height on the surface of a UD sheet without injecting the fiber-reinforced resin. The present invention relates to a fiber-reinforced resin molded body comprising: a first fiber-reinforced resin layer that includes a plurality of reinforcing fibers that have been oriented in one direction and aligned and a matrix resin; a second fiber-reinforced resin layer obtained by arranging blocks including a plurality of reinforcing fibers that have been oriented in one direction and aligned and a matrix resin; and a rib portion that includes a plurality of reinforcing fibers and a matrix resin and protrudes from the surface of the first fiber-reinforced resin layer on the opposite side from the second fiber-reinforced resin layer.

### TECHNICAL FIELD

The present invention relates to a molded body of a fiber reinforced resin and a method for producing the molded body.

### BACKGROUND ART

A fiber reinforced resin sheet (hereinafter also simply referred to as “unidirectional (UD) sheet”) having a shape of a thin film are known. Such a fiber reinforced resin sheet contains a plurality of reinforcing fibers arranged to be aligned in one direction, and a resin composition (matrix resin) spreading through the reinforcing fibers. This UD sheet is used as various reinforcing materials because it has high strength.

As a method of increasing strength of a molded body obtained by molding a resin composition, a protruding portion (rib portion) is provided on the molded body. It is expected that the strength of the molded body of the UD sheet is further improved by providing the rib portion on the molded body obtained by molding the UD sheet. Although a UD sheet has high strength, such a UD sheet has a problem such that formability (moldability) by stamping molding, press molding, or the like is relatively low. Therefore, it is difficult to form a rib portion having a large height by molding the UD sheet.

In order to solve this problem, PTL 1 discloses a method for producing a molded body having a rib portion, the method including the following: molding a UD sheet (or a sheet obtained by cutting the UD sheet) inside a mold that includes a cavity having a shape of a space corresponding to the rib portion; slightly deforming the UD sheet toward the rib portion side; and filling (injecting) the remaining space of the rib portion with another resin material. PTL 1 teaches that with the method, a lower side of the rib portion is molded integrally with the UD sheet, thereby increasing the bonding strength of the rib portion, while a satisfactory height of the rib portion can also be achieved by the injected resin material. In PTL 1, a UD sheet in which cuts are made into reinforcing fibers is disposed, or chips obtained by cutting the UD sheet into a chip shape are randomly disposed. In such a manner in PTL 1, by disposing the reinforcing fibers cut into short pieces on the rib portion side of the UD sheet, the reinforcing fibers can easily flow into the lower side of the rib portion, thereby increasing the bonding strength of the rib portion.

In addition, PTL 2 discloses a method for producing a molded body provided with a rib, the producing method including the following: disposing a UD sheet inside a mold and injecting a thermoplastic resin composition from the side opposite to the side where a rib is to be formed. In this manner, a cavity on the rib side is filled with the thermoplastic resin composition through gaps between reinforcing fibers constituting the UD sheet by injection pressure. PTL 2 teaches that when the rib portion is formed, the flow pressure of the resin composition causes the UD sheet to bend and has a shape so that the UD sheet adheres along a standing wall of the rib portion. PTL 2 describes results of an experiment in which a thermoplastic resin composition including glass fibers is injected to form the rib portion.

### CITATION LIST

### Patent Literature

### PTL 1

Japanese Patent Application Laid-Open No. 2017-80930

### PTL 2

Japanese Patent Application Laid-Open No. 2013-169647

### SUMMARY OF INVENTION

### Technical Problem

As disclosed in PTL 1 and PTL 2, for obtaining a molded body that includes a rib portion by using a UD sheet having low moldability so that it is difficult to mold a rib portion, it is common to inject an additional resin to form the rib portion.

In general, a rib portion is provided to increase the strength of a molded body, it is naturally required that the rib portion itself also has a high strength. In order to increase the strength of the rib portion, it is desirable to use a fiber reinforced resin for the rib portion. However, according to the findings of the present inventors, in the rib portion formed by injection as disclosed in PTL 1 and PTL 2, the strength is not increased as expected even when a fiber reinforced resin is used. Further investigation into this point suggests that when a rib portion is formed by injection, the reinforcing fibers are cut by a pressure during flowing inside an injection machine or during the injection, and the length of the reinforcing fibers in the rib portion is shortened, making it difficult to increase the strength of the rib portion.

On the other hand, when the rib portion is formed by press molding without injection, it is difficult for the fiber reinforced resin to enter a cavity for forming the rib portion, and it is not possible to form the rib portion having a predetermined height. This tendency was particularly noticeable when a fiber reinforced resin including reinforcing fibers having a long fiber length is used in order to increase the strength of the rib portion.

The present invention has been made in view of the problems in the related art, and an object of the present invention is to provide a molded body of a fiber reinforced resin and a method for producing the molded body both having the following feature: a rib portion having a predetermined height can be formed on a surface of a UD sheet without injecting the fiber reinforced resin.

### Solution to Problem

An embodiment of the present invention for achieving the above object relates to a molded body of a fiber reinforced resin according to the following [1] to [10].
[1] A molded body of a fiber reinforced resin, the molded body including:
   a first fiber reinforced resin layer including a plurality of reinforcing fibers arranged to be aligned in one direction and a matrix resin;
   a second fiber reinforced resin layer including blocks each including a plurality of reinforcing fibers arranged to be aligned in one direction and a matrix resin, the blocks being randomly disposed; and
   a rib portion including a plurality of reinforcing fibers and a matrix resin, the rib portion protruding from a surface of the first fiber reinforced resin layer toward a side opposite to the second fiber reinforced resin layer.
[2] The molded body according to [1], in which
   the first fiber reinforced resin layer, the second fiber reinforced resin layer, and the rib portion are integrally molded.
[3] The molded body according to [1] or [2], in which
   the first fiber reinforced resin layer includes, at a portion where the rib portion is formed, a displaced portion in which alignment of the plurality of arranged reinforcing fibers is displaced.
[4] The molded body according to any one of [1] to [3], in which
   an average fiber length of the plurality of reinforcing fibers included in the second fiber reinforced resin layer is substantially identical with an average fiber length of the plurality of reinforcing fibers included in the rib portion.
[5] The molded body according to any one of [1] to [4], in which
   one or some of the plurality of reinforcing fibers included in the rib portion are located across the rib portion and the first fiber reinforced resin layer.
[6] The molded body according to any one of [1] to [5], in which
   the rib portion has a height of 5 mm or more.
[7] The molded body according to any one of [1] to [6], in which
   the first fiber reinforced resin layer has a thickness of 40 μm or more and 3,000 μm or less.
[8] The molded body according to any one of [1] to [7], in which
   the second fiber reinforced resin layer has a thickness of 300 μm or more and 4,000 μm or less.
[9] The molded body according to any one of [1] to [8], in which
   the first fiber reinforced resin layer, the second fiber reinforced resin layer, and the rib portion all include a polyolefin resin as each of the matrix resins.
[10] The molded body according to any one of [1] to [9], in which
   the plurality of reinforcing fibers included in the second fiber reinforced resin layer have an average fiber length of 1 mm or more and 40 mm or less.

Another embodiment of the present invention for achieving the above object relates to a method for producing a molded body of a fiber reinforced resin according to the following to [14].
[11] A method for producing a molded body of a fiber reinforced resin, the method including:
   laminating and disposing, inside a mold, a first fiber reinforced resin and a plurality of second fiber reinforced resins, the first fiber reinforced resin including a plurality of reinforcing fibers arranged to be aligned in one direction and a matrix resin, the plurality of second fiber reinforced resins including blocks each including a plurality of reinforcing fibers arranged to be aligned in one direction and a matrix resin, the blocks each having a smaller size than that of the first fiber reinforced resin, the blocks being randomly aggregated; and
   molding, inside the mold, the disposed first fiber reinforced resin and the plurality of disposed second fiber reinforced resins,
   in which
   the mold includes a cavity section for molding a molded body in the molding, the molded body including a rib portion, and
   in the disposing, the first fiber reinforced resin is disposed on the plurality of second fiber reinforced resins on a side of the cavity section.
[12] The method according to [11], in which
   in the disposing, the plurality of second fiber reinforced resins are disposed inside the mold in such a way that a mass of the plurality of reinforcing fibers included in the plurality of second fiber reinforced resins is 270 g/m² or more and 3,600 g/m² or less per unit area.
[13] The method according to or [12], in which
   in the disposing, the first fiber reinforced resin having a thickness of 0.01 mm or more and 0.5 mm or less is disposed inside the mold.
[14] The method according to any one of to [13], in which
   in the disposing, the plurality of second fiber reinforced resins in which an average fiber length of the plurality of reinforcing fibers is 1 mm or more and 40 mm or less are disposed inside the mold.

### Advantageous Effects of Invention

The present invention can provide a molded body of a fiber reinforced resin and a method for producing the molded body both having the following feature: a rib portion having a predetermined height can be formed on a surface of a UD sheet without injecting the fiber reinforced resin.

### BRIEF DESCRIPTION OF DRAWINGS

FIG. 1 is a perspective view illustrating an exemplary configuration of a molded body of a fiber reinforced resin according to an embodiment of the present invention;

FIG. 2A is a schematic cross-sectional view of the molded body taken along line 2A-2A in FIG. 1, illustrating a cross section of a first fiber reinforced resin layer in an in-plane direction (X-Y direction in FIG. 1), and FIG. 2B is a schematic cross-sectional view of the molded body taken along line 2B-2B in FIG. 1, illustrating a cross section of a second fiber reinforced resin layer in the in-plane direction (X-Y direction in FIG. 1);

FIG. 3 is a schematic cross-sectional view of a rib portion taken along line 3-3 in FIG. 1, illustrating a cross section of the rib portion in an in-plane direction (X-Z direction in FIG. 1);

FIG. 4 is an enlarged cross-sectional view of a portion of the cross section of the first fiber reinforced resin layer illustrated in FIG. 2A, where the portion is in contact with the rib portion;

FIG. 5 is a flowchart of a method of producing the above-described molded body of a fiber reinforced resin, according to another embodiment of the present invention;

FIG. 6 is a perspective view illustrating a schematic shape of a mold used for producing the molded body in the other embodiment of the present invention;

FIG. 7A is a cross-sectional view of a cavity section taken along line 7A-7A in FIG. 6, illustrating a cross section of the cavity section in the longitudinal direction thereof (X-Z direction in FIG. 6), and FIG. 7B is a cross-sectional view of the cavity section taken along line 7B-7B in FIG. 6, illustrating a cross section of the cavity section in the width direction thereof (Y-Z direction in FIG. 6);

FIG. 8 is a schematic cross-sectional view of the mold illustrating a state in which a first fiber reinforced resin and a second fiber reinforced resin are disposed in the mold in step S510;

FIG. 9 is a schematic cross-sectional view of the mold illustrating a state in which the first fiber reinforced resin and the second fiber reinforced resin are molded in step S520, where the cross section is the same as that in FIGS. 7A and 7B; and

FIG. 10 is a schematic cross-sectional view of the mold illustrating the state in which the first fiber reinforced resin and the second fiber reinforced resin are molded in step S520, where the cross section is the same as that in FIGS. 7A and 7B.

### DESCRIPTION OF EMBODIMENTS

### [Molded Body of Fiber Reinforced Resin]

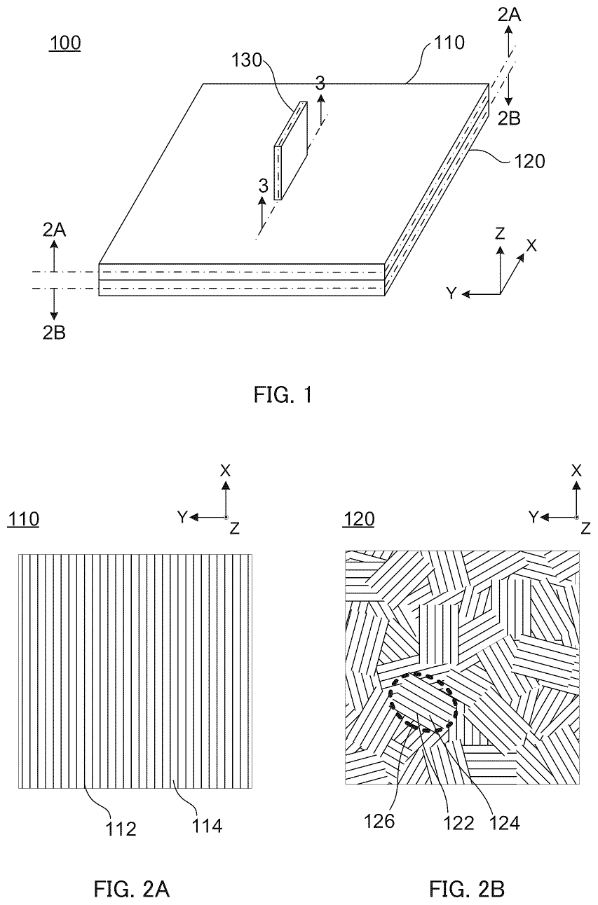

FIG. 1 is a perspective view illustrating an exemplary configuration of a molded body of a fiber reinforced resin according to an embodiment of the present invention.

Molded body 100 of a fiber reinforced resin includes first fiber reinforced resin layer 110, second fiber reinforced resin layer 120, and rib portion 130. Of first fiber reinforced resin layer 110 and second fiber reinforced resin layer 120, the fiber lengths are different from each other and the alignment states are different from each other. Rib portion 130 is disposed in contact with the surface of first fiber reinforced resin layer 110 and protrudes from the surface of first fiber reinforced resin layer 110 toward the side opposite to second fiber reinforced resin layer 120. First fiber reinforced resin layer 110 and second fiber reinforced resin layer 120 are both sheet-shaped fiber reinforced resins and are laminated in the thickness direction of the sheet (Z direction in FIG. 1). Rib portion 130 is a protruding portion made of a fiber reinforced resin and is molded integrally with first fiber reinforced resin layer 110 and second fiber reinforced resin layer 120.

As will be described below, molded body 100 can be produced by laminating a fiber reinforced resin (first fiber reinforced resin) that serves as a material of first fiber reinforced resin layer 110 and a fiber reinforced resin (second fiber reinforced resin) that serves as a material of second fiber reinforced resin layer 120, and performing press molding inside a mold having a space in the shape such that rib portion 130 is located on the first fiber reinforced resin side. During pressing, a matrix resin of the second fiber reinforced resin is melted, and the melted matrix resin and reinforcing fibers of the second fiber reinforced resin flow through the first fiber reinforced resin (between reinforcing fibers 112 included in the first fiber reinforced resin) together. It is considered that the melted matrix resin and the reinforcing fibers of the second fiber reinforced resin, which have flowed through in this manner, and the matrix resin of the first fiber reinforced resin, which has been extruded by the above-described flow, fill the space in the shape of rib portion 130 to form rib portion 130.

FIG. 2A is a cross-sectional view of molded body 100 taken along line 2A-2A in FIG. 1, illustrating a cross section of first fiber reinforced resin layer 110 in an in-plane direction (X-Y direction in FIG. 1). FIG. 2B is a cross-sectional view of molded body 100 taken along line 2B-2B in FIG. 1, illustrating a cross section of second fiber reinforced resin layer 120 in the in-plane direction (X-Y direction in FIG. 1).

### (First Fiber Reinforced Resin Layer)

First fiber reinforced resin layer 110 includes a plurality of reinforcing fibers 112 aligned in one direction (Y direction in FIG. 2A) and matrix resin 114 spreading through reinforcing fibers 112 (i.e., reinforcing fibers 112 are impregnated with matrix resin 114) (see FIG. 2A). In addition, in first fiber reinforced resin layer 110, reinforcing fibers 112 may be partially cut by making slits.

First fiber reinforced resin layer 110 can be formed from a thin film-shaped fiber reinforced resin (UD sheet) that includes the plurality of reinforcing fibers 112 arranged to be aligned in one direction and a resin composition (matrix resin 114) spreading through the reinforcing fibers. At this time, one UD sheet may be used to form first fiber reinforced resin layer 110 composed of a single layer, or a plurality of UD sheets may be used to form first fiber reinforced resin layer 110 composed of a plurality of layers. When first fiber reinforced resin layer 110 is formed from a plurality of UD sheets, layers (i.e., layers derived from respective UD sheets) included in first fiber reinforced resin layer 110 may be laminated such that angles at which reinforcing fibers 112 are aligned are the same across the layers, or may be laminated such that the angles at which reinforcing fibers 112 are aligned are different between the layers. From the viewpoint of increasing strength of first fiber reinforced resin layer 110 against loads applied from a plurality of directions, it is preferable that first fiber reinforced resin layer 110 includes a plurality of layers in which the angles at which reinforcing fibers 112 are aligned are different between the layers. At this time, the plurality of layers may include only one or a plurality of layers in which the angles at which reinforcing fibers 112 are aligned are different from a reference layer in only one direction (for example, one or a plurality of layers in which the alignment angles are 90° with respect to the reference layer (0°)), or may include one or a plurality of layers in which the angles at which reinforcing fibers 112 are aligned are different from the reference layer in different directions (for example, one or a plurality of layers in which the alignment angles are 45°, 90°, and 135° with respect to the reference layer (0°)). When first fiber reinforced resin layer 110 includes a plurality of layers in which the angles at which reinforcing fibers 112 are aligned are different from layer to layer, it is preferable to set the alignment angles of reinforcing fibers 112 included in respective layers such that the angles, in the plurality of layers, at which reinforcing fibers 112 are aligned are pseudo-isotropic (that is, when first fiber reinforced resin layer 110 is viewed as a whole, layers in which the reinforcing fibers 112 are aligned equally in respective directions are disposed) (for example, 0°/90°/0°, 0°/45°/90°/135°/135°/90°/45°/0°, or the like).

From the viewpoint of making it easy for the reinforcing fibers and the matrix resin of second fiber reinforced resin layer 120 to pass between reinforcing fibers 112 during the molding of molded body 100 to easily form a higher rib portion 130, it is preferable that the angle at which reinforcing fibers 112 are aligned in a layer—among the layers included in first fiber reinforced resin layer 110)—disposed at a position closest to the rib portion is substantially the same as the longitudinal direction of rib portion 130. In the present specification, the term “substantially the same” means that, between two values, the difference between the larger value and the smaller value is within 10% of the larger value.

From the viewpoint of further increasing the strength of rib portion 130, it is preferable that first fiber reinforced resin layer 110 includes a layer in which the angle at which reinforcing fibers 112 are aligned is different from the longitudinal direction of rib portion 130. Itis considered that in such a layer, reinforcing fibers 112 included in the layer serve as wedges that connect the reinforcing fibers that are located across first fiber reinforced resin layer 110 and rib portion 130, making the reinforcing fibers in rib portion 130 less likely to collapse and making rib portion 130 less likely to be destroyed. In particular, when the angle at which reinforcing fibers 112 are aligned in the layer (among the layers included in first fiber reinforced resin layer 110) disposed at the position closest to the rib portion is different from the longitudinal direction of rib portion 130, the strength of rib portion 130 is more likely to be increased. In addition, when first fiber reinforced resin layer 110 includes a layer in which the angle at which reinforcing fibers 112 are aligned is the same as the longitudinal direction of rib portion 130 or a layer in which the angle at which reinforcing fibers 112 are aligned is 90° with respect to the longitudinal direction of rib portion 130, the appearance of the rib portion is more likely to be improved.

When first fiber reinforced resin layer 110 is formed from a plurality of UD sheets, the number of layers of first fiber reinforced resin layer 110 is preferably 2 or more and 24 or less. As the number of layers becomes smaller, the moldability of first fiber reinforced resin layer 110 is increased and molded body 100 having a more complex shape is easily formed. As the number of layers becomes larger, the reinforcing fiber layers can be laminated to control the strength in a specific direction. As the number of layers becomes smaller, it is easy to form rib portion 130 having a greater height. From the above-described viewpoints, the number of layers is more preferably 2 or more and 18 or less.

The fiber length (average fiber length) of reinforcing fibers 112 can be set to 15 mm or more, and is preferably 20 mm or more, more preferably 100 mm or more, and still more preferably 500 mm or more. As the fiber length of reinforcing fibers 112 becomes larger, the strength of first fiber reinforced resin layer 110 is increased, and the strength of molded body 100 imparted by first fiber reinforced resin layer 110 is increased. The upper limit of the fiber length of reinforcing fibers 112 can be appropriately determined depending on the shape and size of molded body 100, and is, for example, 50 mm or less.

The average diameter of reinforcing fibers 112 is preferably 1 μm or more and 20 μm or less, and more preferably 4 μm or more and 10 μm or less. As the average diameter of reinforcing fibers 112 becomes larger, the strength of first fiber reinforced resin layer 110 is increased, and the strength of molded body 100 imparted by first fiber reinforced resin layer 110 is increased. As the average diameter of reinforcing fibers 112 becomes smaller, the reinforcing fibers and the matrix resin of second fiber reinforced resin layer 120 are more likely to pass between reinforcing fibers 112 during the molding of molded body 100, and rib portion 130 having a greater height is more likely to be formed.

The type of reinforcing fibers 112 is not particularly limited, and any one of carbon fibers, glass fibers, aramid fibers, alumina fibers, silicon carbide fibers, boron fibers, metal fibers, and the like may be used as the reinforcing fibers. In particular, carbon fibers and glass fibers are preferred, and carbon fibers are more preferred.

Reinforcing fibers 112 may be subjected to a sizing treatment with a sizing agent. The sizing agent is not particularly limited, but is preferably a modified polyolefin and more preferably a modified polyolefin containing a carboxylic acid metal salt. The modified polyolefin is, for example, obtained by grafting a carboxylic acid group, a carboxylic anhydride group or a carboxylic ester group onto the polymer chain of an unmodified polyolefin and forming a salt between the functional group and a metal cation.

Unmodified polyolefin is preferably an ethylene polymer with a content of the constituent unit derived from ethylene of 50 mol % or more, or a propylene polymer with a content of the constituent unit derived from propylene of 50 mol % or more. Examples of the ethylene polymer include ethylene homopolymer and copolymers of ethylene and an α-olefin having 3 or more and 10 or less carbon atoms. Examples of the propylene polymer include propylene homopolymer and copolymers of propylene and ethylene or an α-olefin having 4 or more and 10 or less carbon atoms. The unmodified polyolefin is preferably propylene homopolymer, ethylene homopolymer, ethylene/propylene copolymer, propylene/1-butene copolymer, or ethylene/propylene/1-butene copolymer. The α-olefin constituting the unmodified polyolefin and the modified polyolefin may be any α-olefin derived from fossil fuels or from biomass raw materials, or a mixture thereof.

Reinforcing fibers 112 are arranged to be aligned in one direction and are located in matrix resin 114.

A material of matrix resin 114 is not particularly limited, and may be a thermoplastic resin or a thermosetting resin. Matrix resin 114 may be a crystalline resin or an amorphous resin. The thermoplastic resin or the thermosetting resin may be any thermoplastic resin or the thermosetting resin derived from fossil fuels or from biomass raw materials, or a mixture thereof.

Examples of the thermoplastic resin include polyolefin resins such as polyethylene, polypropylene, polybutene, and poly(4-methyl-1-pentene), polyamide resin, polyester resin, polystyrene resin, thermoplastic polyimide resin, polyamideimide resin, polycarbonate resin, polyphenylene ether resin, polyphenylene sulfide resin, polyacetal resin, acrylic resin, polyetherimide resin, polysulfone resin, polyetherketone resin, polyetheretherketone resin, polyarylateresin, polyethernitrile resin, vinyl chloride resin, ABS resin, and fluororesin.

Examples of the thermosetting resins include epoxy resin, phenol resin, melamine resin, urea resin, diallyl phthalate resin, silicone resin, urethane resin, furan resin, ketone resin, xylene resin, thermosetting polyimide resin, unsaturated polyester resin, and diallyl terephthalate resin.

Among these, from the viewpoint of further improving the formability of first fiber reinforced resin layer 110 and easily allowing the reinforcing fibers and the matrix resin derived from second fiber reinforced resin layer 120 to pass between reinforcing fibers 112 during the molding of molded body 100, a thermoplastic resin is preferable. In addition, among the thermoplastic resins, a polyamide resin and a polyolefin resin are preferable, and from the viewpoint of enabling molding at a lower temperature to further improve production efficiency, a polyolefin resin is more preferable, and polypropylene is still more preferable.

Matrix resin 114 may be a resin composition containing an additive. Examples of the additive include known fillers (inorganic fillers and organic fillers), pigments, dyes, weather-resistant stabilizers, heat-resistant stabilizers, antistatic agents, anti-slip agents, antioxidants, antifungal agents, antibacterial agents, flame retardants, and softeners. For example, when the UD sheet is fused by irradiation with a laser during the producing of molded body 100, it is preferable that matrix resin 114 is a resin composition containing a coloring agent that absorbs a laser having a wavelength of irradiation. Any coloring agent that absorbs light with a wavelength of 300 nm or more and 3,000 nm or less may be used, and carbon black is preferred.

In addition, matrix resin 114 may contain an additional component such as a resin other than the above described resins or short fibers having a length shorter than that of reinforcing fibers 112.

The melt flow rate (MFR) of matrix resin 114 measured according to ASTM D1238 at 230° C. under a load of 2.16 kg is preferably 100 g/10 min or more, and more preferably 130 g/10 min or more and 500 g/10 min or less. When the MFR is within the above-described range, the reinforcing fibers and the matrix resin derived from second fiber reinforced resin layer 120 are more likely to pass between reinforcing fibers 112 during the molding of molded body 100, and rib portion 130 having a greater height is more likely to be formed.

The content (fiber volume fraction (Vf)) of reinforcing fibers 112 based on the total volume of first fiber reinforced resin layer 110 is preferably 10% by volume or more and 70% by volume or less, more preferably 15% by volume or more and 60% by volume or less, and still more preferably 20% by volume or more and 60% by volume or less. As the fiber volume fraction (Vf) becomes larger, the strength of first fiber reinforced resin layer 110 can be increased, and the strength of molded body 100 imparted by first fiber reinforced resin layer 110 can be increased. As the fiber volume fraction (Vf) becomes smaller, the reinforcing fibers and the matrix resin derived from second fiber reinforced resin layer 120 are more likely to pass between reinforcing fibers 112 during the molding of molded body 100, and rib portion 130 having a greater height is more likely to be formed.

The thickness of first fiber reinforced resin layer 110 is preferably 40 μm or more and 3,000 μm or less, more preferably 100 μm or more and 2,000 μm or less, still more preferably 150 μm or more and 1,500 μm or less, and particularly preferably 300 μm or more and 1,200 μm or less. As the thickness of first fiber reinforced resin layer 110 becomes larger, the strength of first fiber reinforced resin layer 110 is increased, and the strength of molded body 100 imparted by first fiber reinforced resin layer 110 is also increased. As the thickness of first fiber reinforced resin layer 110 becomes smaller, the strength of rib portion 130 is increased, and scratches, cracking, or the like is less likely to occur in rib portion 130 during the molding, and therefore the appearance of rib portion 130 is improved. From the same viewpoints, it is preferable that the thickness of first fiber reinforced resin layer 110 is smaller than the thickness of second fiber reinforced resin layer 120.

### (Second Fiber Reinforced Resin Layer)

In second fiber reinforced resin layer 120, blocks 126 each including a plurality of reinforcing fibers 122 aligned in one direction and matrix resin 124 are randomly disposed (see FIG. 2B). Second fiber reinforced resin layer 120 imparts a marble-like appearance to molded body 100 due to a plurality of randomly disposed blocks. In addition, second fiber reinforced resin layer 120 also serves as a material of rib portion 130 during the molding.

As second fiber reinforced resin layer 120, it is possible to use a sheet obtained as follows (hereinafter, also simply referred to as a “random sheet”): chopped sheets are formed by cutting a UD sheet into small pieces and randomly disposing the chopped sheets, which are molded into a sheet shape using a known press molding machine or the like. At this time, each chopped sheet serves as each block 126 in second fiber reinforced resin layer 120.

The chopped sheet may have a shape corresponding to the fiber length and dispersion of reinforcing fibers 122 in each block 126. The width of the chopped sheet in a direction orthogonal to the alignment direction of the reinforcing fibers is preferably 3 mm or more and 50 mm or less. When the width in the above-described direction is 3 mm or more, both the formability of the chopped sheet and the moldability of molded body 100 can be improved. When the width in the above-described direction is 50 mm or less, the strength of the molded body can be further increased. From the above-described viewpoints, the width in the above-described direction is more preferably 10 mm or more and 25 mm or less.

In addition, the length of the chopped sheet in the alignment direction of the reinforcing fibers is preferably 5 mm or more and 50 mm or less. When the length in the above-described direction is 5 mm or more, the strength of the molded body can be further increased. When the length in the above-described direction is 50 mm or less, all of the moldability of the chopped sheet, the formability of molded body 100, and the appearance of the molded body can be improved. From the above-described viewpoints, the length in the above-described direction is more preferably 10 mm or more and 30 mm or less.

In addition, a ratio (aspect ratio: length/width) of the length of the chopped sheet in the alignment direction of the reinforcing fibers to the width of the chopped sheet in the direction orthogonal to the alignment direction of the reinforcing fibers is preferably 0.5 or more and 5.0 or less. When the aspect ratio is 0.5 or more, the chopped sheet is less likely to be broken, and the strength of the molded body tends to be improved. When the aspect ratio is 5.0 or less, the fibers become shorter, and thus the formability tends to be further improved. From the above-described viewpoints, the aspect ratio is more preferably 1.0 or more and 3.0 or less.

For example, a random sheet in which the reinforcing fibers are aligned in the in-plane direction and the alignment direction in the in-plane direction is random can be obtained as follows: the chopped sheets are spread randomly (the alignment directions of the fibers are different between the chopped sheet) without gaps inside a mold of a press molding machine, and press molding is performed. Alternatively, the chopped sheets may be spread non-randomly (so that the alignment directions of all the fibers are the same or the alignment directions of the fibers of respective chopped sheets are offset but overall there is an alignment in the fiber alignment direction) and press molding is performed, and thus blocks 126 are disposed non-randomly in second fiber reinforced resin layer 120.

The fiber length (average fiber length) of reinforcing fibers 122 included in each block 126 is shorter than the fiber length (average fiber length) of reinforcing fibers 112 included in first fiber reinforced resin layer 110. The fiber length of reinforcing fibers 122 is typically 50 mm or less, and is preferably 1 mm or more and 40 mm or less, more preferably 3 mm or more and 40 mm or less, and still more preferably 6 mm or more and 35 mm or less. As the fiber length of reinforcing fibers 122 becomes longer, the strength of molded body 100 and rib portion 130 is increased. As the fiber length of reinforcing fibers 122 becomes shorter, the moldability of second fiber reinforced resin layer 120 is increased, and reinforcing fibers 122 are more likely to pass between reinforcing fibers 112 included in the first fiber reinforced resin layer during the molding of molded body 100, so that rib portion 130 having a greater height is more likely to be formed.

The average diameter of reinforcing fibers 122 is preferably 1 μm or more and 20 μm or less, and more preferably 4 μm or more and 10 μm or less. As the average diameter of reinforcing fibers 122 becomes larger, the strengths of molded body 100 and rib portion 130 are increased. As the average diameter of reinforcing fibers 122 becomes smaller, reinforcing fibers 122 are more likely to pass between reinforcing fibers 112 included in first fiber reinforced resin layer 110 during the molding of molded body 100, and rib portion 130 having a greater height is more likely to be formed.

The type of reinforcing fibers 122 is not particularly limited, and any one of carbon fibers, glass fibers, aramid fibers, alumina fibers, silicon carbide fibers, boron fibers, metal fibers, and the like can be used as the reinforcing fibers. Among these, carbon fibers and glass fibers are preferable, and carbon fibers are more preferable from the viewpoint that the carbon fibers are less likely to be cut when the carbon fibers pass between reinforcing fibers 112 included in first fiber reinforced resin layer 110 during the molding, and as a result, rib portion 130 can be filled with the long reinforcing fibers 122, thereby easily increasing the strength of rib portion 130.

Reinforcing fibers 122 included in second fiber reinforced resin layer 120 may be the same type of reinforcing fibers as reinforcing fibers 112 included in first fiber reinforced resin layer 110, or may be reinforcing fibers of a different type, but the same type of reinforcing fibers are preferable.

Reinforcing fibers 122 may be subjected to a sizing treatment with a sizing agent. The sizing agent is not particularly limited, and for example, various types of sizing agents described for reinforcing fibers 112 included in first fiber reinforced resin layer 110 can be used in the same manner.

Reinforcing fibers 122 are arranged to be aligned in one direction inside each block 126 and are located in matrix resin 124.

A material of matrix resin 124 is not particularly limited, and may be a thermoplastic resin or a thermosetting resin. Matrix resin 124 may be a crystalline resin or an amorphous resin. As matrix resin 124, various resins described for matrix resin 114 included in first fiber reinforced resin layer 110 can be used in the same manner. Among these, from the viewpoint of easily allowing the matrix resin to pass between reinforcing fibers 112 included in first fiber reinforced resin layer 110 during the molding of molded body 100, a thermoplastic resin is preferable. In addition, among the thermoplastic resins, a polyamide resin and a polyolefin resin are preferable, and from the viewpoint of enabling molding at a lower temperature to further improve production efficiency, a polyolefin resin is more preferable, and polypropylene is still more preferable.

Matrix resin 124 included in second fiber reinforced resin layer 120 may be a resin of the same type as matrix resin 114 included in first fiber reinforced resin layer 110, or may be a resin of a different type, but from the viewpoint of improving the fusing property between first fiber reinforced resin layer 110 and second fiber reinforced resin layer 120 and the fusing property between first fiber reinforced resin layer 110 and rib portion 130, a resin of the same type is preferable. In particular, it is preferable that both matrix resin 124 and matrix resin 114 are polypropylene.

In addition, matrix resin 124 may contain various additives, an additional component such as a resin other than the above described resins, short fibers having a length shorter than that of reinforcing fibers 122, or the like, in the same manner as matrix resin 114 included in first fiber reinforced resin layer 110.

It is preferable that a melt flow rate (MFR) of matrix resin 124 measured according to ASTM D1238 at 230° C. under a load of 2.16 kg is the same as or larger than the MER of matrix resin 114 included in first fiber reinforced resin layer 110. By setting the MFR of matrix resin 124 to be the same as or larger than the MFR of matrix resin 114 (in other words, to make the fluidity of matrix resin 124 approximately equal to that of matrix resin 113, or to make matrix resin 124 of second fiber reinforced resin layer 120 more fluid), reinforcing fibers 122 and matrix resin 124 are more likely to pass between reinforcing fibers 112 included in first fiber reinforced resin layer 110 during the molding of molded body 100, and rib portion 130 having a greater height is more likely to be formed.

Specifically, matrix resin 124 has a melt flow rate (MFR) of preferably 150 g/10 min or more, and more preferably 180 g/10 min or more and 600 g/10 min or less, as measured according to ASTM D1238 at 230° C. under a load of 2.16 kg. When the MER is within the above-described range, the reinforcing fibers and the matrix resin derived from second fiber reinforced resin layer 120 are more likely to pass between reinforcing fibers 112 during the molding of molded body 100, and rib portion 130 having a greater height is more likely to be formed.

The content (fiber volume fraction (Vf)) of reinforcing fibers 122 based on the total volume of second fiber reinforced resin layer 120 is preferably 10% by volume or more and 65% by volume or less, more preferably 10% by volume or more and 60% by volume or less, and still more preferably 15% by volume or more and 55% by volume or less. As the fiber volume fraction (Vf) becomes larger, the strength of first fiber reinforced resin layer 110 can be increased, and the strength of molded body 100 imparted by first fiber reinforced resin layer 110 can be increased. As the fiber volume fraction (Vf) becomes smaller, the reinforcing fibers and the matrix resin derived from second fiber reinforced resin layer 120 are more likely to pass between reinforcing fibers 112 during the molding of molded body 100, and rib portion 130 having a greater height is more likely to be formed.

In second fiber reinforced resin layer 120, the mass of reinforcing fibers 122 per unit area is preferably 270 g/m² or more and 3,600 g/m² or less, more preferably 350 g/m² or more and 2,400 g/m² or less, and still more preferably 400 g/m² or more and 1,500 g/m² or less. As the mass of reinforcing fibers 122 per unit area becomes larger, a larger amount of the reinforcing fibers is more likely to fill rib portion 130, and the strength of rib portion 130 is further increased. As the mass of reinforcing fibers 122 per unit area becomes smaller, scratches, cracking, or the like is less likely to occur in rib portion 130 during the molding, and the appearance of rib portion 130 is further improved.

The thickness of second fiber reinforced resin layer 120 is preferably 300 μm or more and 4,000 μm or less, more preferably 300 μm or more and 3,000 μm or less, still more preferably 400 μm or more and 2,000 μm or less, and particularly preferably 400 μm or more and 1,200 μm or less. As the thickness of second fiber reinforced resin layer 120 becomes larger, rib portion 130 having a greater height is more likely to be formed. As the thickness of second fiber reinforced resin layer 120 becomes smaller, molded body 100 can be made thinner and the applications of molded body 100 can be further widened.

### (Rib Portion)

Rib portion 130 is a convex structure formed on the first fiber reinforced resin side by a material (reinforcing fibers 122 and matrix resin 124) of the second fiber reinforced resin flowing between reinforcing fibers 112 of the first fiber reinforced resin during the molding of molded body 100. In the present embodiment, first fiber reinforced resin layer 110, second fiber reinforced resin layer 120, and rib portion 130 are integrally formed by the above-described producing method. In other words, a clear bonding interface is not generated between first fiber reinforced resin layer 110 and rib portion 130 and between first fiber reinforced resin layer 110 and second fiber reinforced resin layer 120.

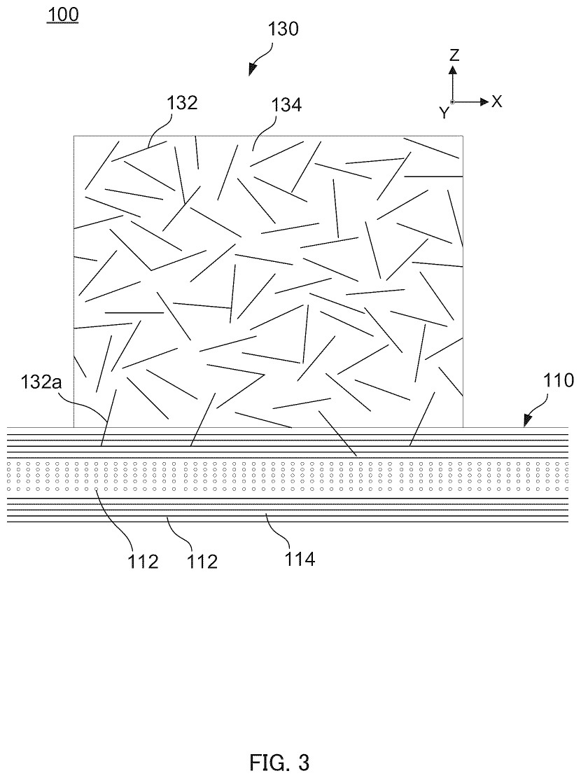

FIG. 3 is a cross-sectional view of rib portion 130 taken along line 3-3 in FIG. 1, illustrating a cross section of rib portion 130 in an in-plane direction (X-Z direction in FIG. 1). In order to facilitate understanding, FIG. 3 also illustrates a cross section of a part of first fiber reinforced resin layer 110 (first fiber reinforced resin layer 110 illustrated in FIG. 3 includes a plurality of layers in which the alignment directions of reinforcing fibers 112 are different between the layers). In addition, second fiber reinforced resin layer 120 is not illustrated in FIG. 3.

Rib portion 130 includes a plurality of reinforcing fibers 132 and matrix resin 134 spreading through reinforcing fibers 132 (see FIG. 3). Basically, the plurality of reinforcing fibers 132 are randomly dispersed and disposed, but may be aligned in one direction (for example, a direction away from first fiber reinforced resin layer 110, i.e., in the Z direction in FIG. 3) in rib portion 130. The alignment at this time is as follows: a plurality of reinforcing fibers do not need to be arranged to be aligned in the same direction such as in first fiber reinforced resin layer 110 and each block 126 of second fiber reinforced resin layer 120; and the plurality of reinforcing fibers 132 are disposed in such a way that although the alignment directions of the respective fibers are offset, there is an alignment in the fiber alignment direction to some extent when viewed as a whole.

In the present embodiment, reinforcing fibers 132 are uniformly disposed in the entire rib portion 130, and the entire rib portion 130 is uniformly impregnated with matrix resin 134. However, the disposition of reinforcing fibers 132 and matrix resin 134 is not limited thereto. For example, a density of reinforcing fibers 132 may be changed between a tip side (a side far from first fiber reinforced resin layer 110) of rib portion 130 and a root side (a side close to first fiber reinforced resin layer 110) of rib portion 130 (for example, the density of reinforcing fibers 132 may be higher on the tip side of rib portion 130 and lower on the root side of rib portion 130, or the density of reinforcing fibers 132 may be lower on the tip side of rib portion 130 and higher on the root side of rib portion 130). Alternatively, for example, the composition of matrix resin 134 may be changed in a stepwise manner between the tip side and the root side of rib portion 130 (for example, the composition on the tip side of rib portion 130 may be close to that of matrix resin 114 included in first fiber reinforced resin layer 110, and the composition on the root side of rib portion 130 may be close to that of matrix resin 124 included in second fiber reinforced resin layer 120). The disposition of reinforcing fibers 132 and matrix resin 134 can be changed depending on conditions (pressure, temperature, time, and the like) during the molding.

The fiber length (average fiber length) of reinforcing fibers 132 is shorter than the fiber length (average fiber length) of reinforcing fibers 112 included in first fiber reinforced resin layer 110. In addition, the fiber length (average fiber length) of reinforcing fibers 132 is substantially the same as the fiber length (average fiber length) of reinforcing fibers 122 included in second fiber reinforced resin layer 120. The fiber length of reinforcing fibers 132 is typically 50 mm or less, and is preferably 1 mm or more and 40 mm or less, more preferably 3 mm or more and 40 mm or less, and still more preferably 6 mm or more and 35 mm or less. As the fiber length of reinforcing fibers 132 becomes longer, the strength of rib portion 130 is increased. As the fiber length of reinforcing fibers 132 becomes shorter, the strength of rib portion 130 is further increased.

The average diameter of reinforcing fibers 132 is substantially the same as the average diameter of reinforcing fibers 122 included in second fiber reinforced resin layer 120, and is preferably 1 μm or more and 20 μm or less, and more preferably 4 μm or more and 10 μm or less.

The type of reinforcing fibers 132 is not particularly limited, and any one of carbon fibers, glass fibers, aramid fibers, alumina fibers, silicon carbide fibers, boron fibers, metal fibers, and the like can be used as the reinforcing fibers. In particular, carbon fibers and glass fibers are preferred, and carbon fibers are more preferred.

Reinforcing fibers 132 included in rib portion 130 are reinforcing fibers of the same type as reinforcing fibers 122 included in second fiber reinforced resin layer 120. Reinforcing fibers 132 included in rib portion 130 may be the same type of reinforcing fibers as reinforcing fibers 112 included in first fiber reinforced resin layer 110, or may be reinforcing fibers of a different type, but the same type of reinforcing fibers are preferable.

Reinforcing fibers 132 may be subjected to a sizing treatment with a sizing agent, in the same manner as reinforcing fibers 122 included in second fiber reinforced resin layer 120.

Matrix resin 134 is a resin of the same type as matrix resin 114 included in first fiber reinforced resin layer 110, a resin of the same type as matrix resin 124 included in second fiber reinforced resin layer 120, or a mixture of matrix resin 114 and matrix resin 124.

The content (fiber volume fraction (Vf)) of reinforcing fibers 132 based on the total volume of rib portion 130 is preferably 10% by volume or more and 65% by volume or less, more preferably 10% by volume or more and 60% by volume or less, and still more preferably 15% by volume or more and 55% by volume or less. As the Vf becomes larger, the strength of rib portion 130 is increased. As the Vf becomes smaller, the formation of rib portion 130 becomes easy. The Vf of rib portion 130 may be smaller than the Vf of second fiber reinforced resin layer 120.

In rib portion 130, the mass of reinforcing fibers 132 per unit area is preferably 13,000 g/m² or more and 66,000 g/m² or less, more preferably 18,000 g/m² or more and 56,000 g/m² or less, and still more preferably 23,000 g/m² or more and 46,000 g/m² or less.

The length and Vf of reinforcing fibers 132 included in rib portion 130 can be calculated as follows: matrix resin 134 in the root portion of rib portion 130 is heated to a temperature equal to or higher than the melting point of matrix resin 134 and not affecting reinforcing fibers 132; matrix resin 134 is melted; rib portion 130 is pulled out from molded body 100; and the pulled-out rib portion 130 is heated or the pulled-out rib portion 130 is treated with an organic resin to remove matrix resin 134 to obtain reinforcing fibers 132; and perform calculation using the obtained reinforcing fibers 132. The fiber length may be an average length of 100 reinforcing fibers 132 obtained in this manner.

When molded body 100 is produced, reinforcing fibers 122 that have flowed from the second fiber reinforced resin do not have to completely pass through first fiber reinforced resin layer 110, and some of the fibers may remain to be disposed inside first fiber reinforced resin layer 110 or may be disposed across rib portion 130 and first fiber reinforced resin layer 110 (reinforcing fibers 132a illustrated in FIG. 3).

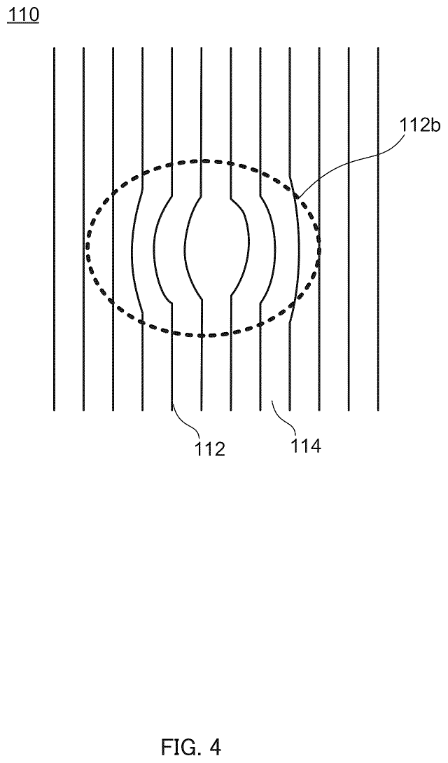

FIG. 4 is an enlarged cross-sectional view of a portion of the cross section of first fiber reinforced resin layer 110 illustrated in FIG. 2A, where the portion is in contact with rib portion 130. As illustrated in FIG. 4, in the portion of first fiber reinforced resin layer 110 (the portion is in contact with rib portion 130), some of reinforcing fibers 112 may be partially bent when reinforcing fiber 122 pass through, and the alignment of the fibers may be partially displaced (displaced portion 112b illustrated in FIG. 4). Reinforcing fibers 122 and matrix resin 124 of the second fiber reinforced resin pass through the displaced portion 112b in which reinforcing fibers 112 are bent.

The shape, size, and disposition position of rib portion 130 can be appropriately determined depending on the application of molded body 100.

For example, the height of rib portion 130 (length from the connecting portion with first fiber reinforced resin layer 110 to the tip of rib portion 130) is preferably 5 mm or more, more preferably 10 mm or more, and still more preferably 12 mm or more. The upper limit of the height of rib portion 130 is not particularly limited, and is, for example, 50 mm or less,

In addition, the length of rib portion 130 (a length of a long side of rib portion 130 in a plane parallel to the surface of first fiber reinforced resin layer 110) is preferably 100 mm or less, more preferably 80 mm or less, and still more preferably 60 mm or less. The lower limit of the length of rib portion 130 is not particularly limited, and is, for example, 5 mm or more.

In addition, the thickness of rib portion 130 (thickness in a direction orthogonal to the long side of rib portion 130 in a plane parallel to the surface of first fiber reinforced resin layer 110) is preferably 3 mm or less, more preferably 2.5 mm or less, and still more preferably 2 mm or less. The lower limit of the thickness of rib portion 130 is not particularly limited, and is, for example, 1 mm or more.

As described above, the molded body according to the present embodiment has a configuration in which second fiber reinforced resin layer 120, first fiber reinforced resin layer 110, and rib portion 130 are laminated in this order. Another layer may be disposed between these layers and/or the layer and the rib portion; however, it is preferable that no other layer is disposed, and these layers and the rib portion are in direct contact with each other. Molded body 100 may include other layers outside these layers and the rib portion. For example, molded body 100 may include a protective layer that protects the appearance of second fiber reinforced resin layer 120 and is transparent or translucent to an extent that the pattern of second fiber reinforced resin layer 120 can be visually recognized, on the outer surface of second fiber reinforced resin layer 120 (i.e., the surface on the side opposite to rib portion 130). The protective layer may be, for example, a thin film layer made of a resin.

### [Method for Producing Molded Body of Fiber Reinforced Resin]

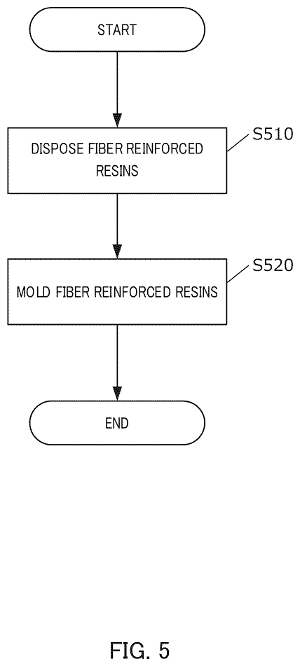

FIG. 5 is a flowchart of a method of producing the above-described molded body 100 of a fiber reinforced resin according to another embodiment of the present invention.

As illustrated in FIG. 5, molded body 100 is produced by the following steps: a step (step S510) of laminating and disposing the first fiber reinforced resin and the second fiber reinforced resin in a mold for molding; and a step (step S520) of molding the disposed first fiber reinforced resin and second fiber reinforced resin inside the mold.

### (Step S510: Disposing of Fiber Reinforced Resin)

In the present step, the first fiber reinforced resin and the second fiber reinforced resin are laminated and disposed in a mold for molding.

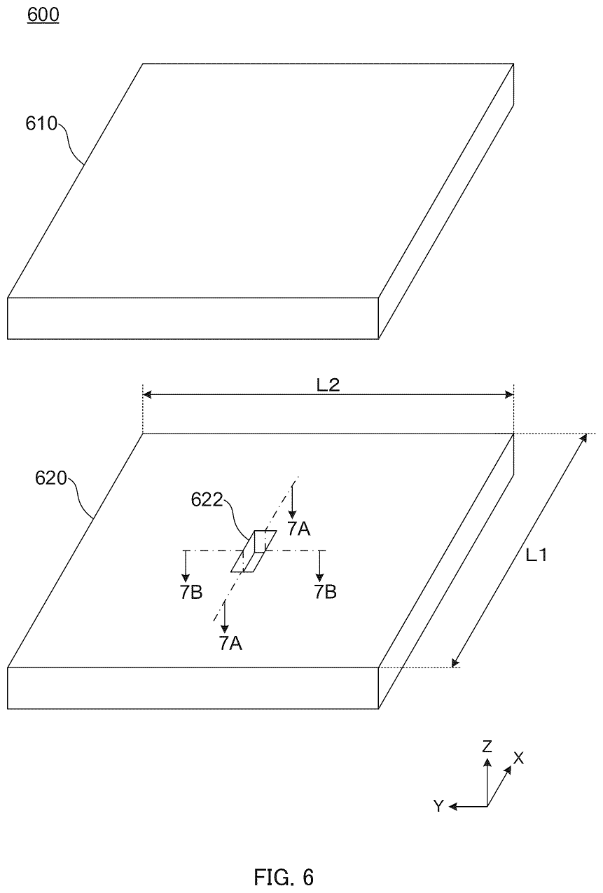

FIG. 6 is a perspective view illustrating a schematic shape of mold 600 used for producing molded body 100 in the present embodiment. Mold 600 includes core mold 610 and cavity mold 620 disposed to face each other, and is configured to be capable of mold clamping and mold opening by moving core mold 610 and cavity mold 620 relative to each other in a direction moving closer to each other and a direction moving away from each other. Cavity section 622 having the same shape as rib portion 130 to be formed is provided in the center portion of the molding surface of cavity mold 620. As illustrated in FIG. 6, cavity section 622 is a substantially rectangular parallelepiped space that is open to the molding surface of cavity mold 620.

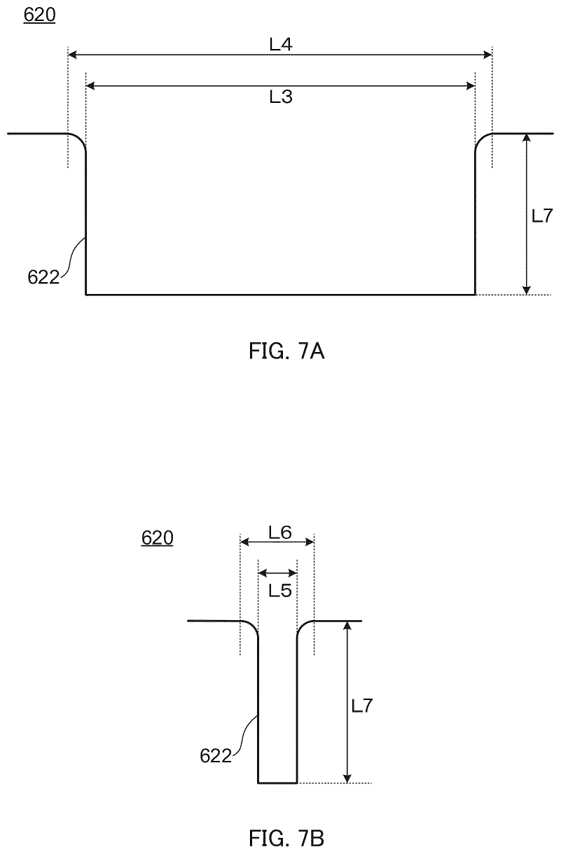

FIG. 7A is a cross-sectional view of cavity section 622 taken along line 7A-7A in FIG. 6, illustrating a cross section of cavity section 622 in the longitudinal direction thereof (X-Z direction in FIG. 6). FIG. 7B is a cross-sectional view of cavity section 622 taken along line 7B-7B in FIG. 6, illustrating a cross section of cavity section 622 in the width direction thereof (Y-Z direction in FIG. 6). As illustrated in FIGS. 7A and 7B, the edge of the opening portion in cavity section 622 is rounded. The shape of cavity section 622 is not limited thereto and may be any shape determined depending on the shape of rib portion 130 of molded body 100 to be produced.

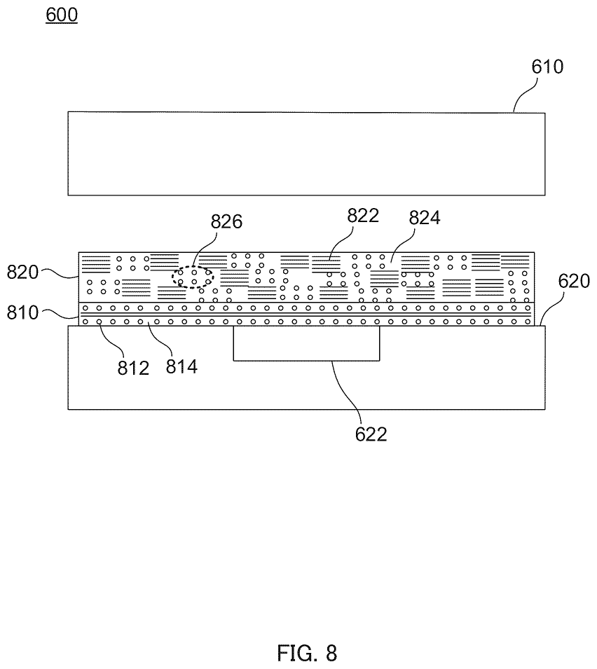

FIG. 8 is a schematic cross-sectional view of mold 600 illustrating a state in which a first fiber reinforced resin and a second fiber reinforced resin are disposed in the mold in the present step. In the present step, first fiber reinforced resin 810 including a plurality of reinforcing fibers 812 arranged to be aligned in one direction and matrix resin 814 is disposed on the molding surface of cavity mold 620 in such a way that the first fiber reinforced resin is in contact with the opening of cavity section 622. Second fiber reinforced resin 820 is stacked to be disposed on a surface (a surface opposite to cavity section 622) of first fiber reinforced resin 810. In second fiber reinforced resin 820, a plurality of blocks 826 are aggregated, and each block includes a plurality of reinforcing fibers 822 arranged to be aligned in one direction and matrix resin 824 and has a smaller size than the first fiber reinforced resin.

First fiber reinforced resin 810 is typically a UD sheet and serves as a material of first fiber reinforced resin layer 110 in molded body 100. Second fiber reinforced resin 820 is typically an aggregate of chopped sheets obtained by cutting a UD sheet into small pieces, and serves as a material of second fiber reinforced resin layer 120 in molded body 100. Therefore, as reinforcing fibers 812 and matrix resin 814 included in first fiber reinforced resin 810, reinforcing fibers 112 and matrix resin 114 that can be included in first fiber reinforced resin layer 110 described above can be used, and as reinforcing fibers 822 and matrix resin 824 included in second fiber reinforced resin 820, reinforcing fibers 122 and matrix resin 124 that can be included in second fiber reinforced resin layer 120 described above can be used. In addition, the size of the chopped sheet (block 826) can be in the range described for second fiber reinforced resin layer 120.

As described above, molded body 100 may include, inside first fiber reinforced resin layer 110, a plurality of layers in which the alignment directions of reinforcing fibers 112 are different between the layers. In a case of using such first fiber reinforced resin layer 110, in the present step, a plurality of UD sheets may be laminated such that the alignment directions of the reinforcing fibers are different between the layers, thereby forming first fiber reinforced resin layer 110.

The thickness of first fiber reinforced resin 810 is preferably 0.04 mm or more and 3 mm or less, more preferably 0.1 mm or more and 2 mm or less, still more preferably 0.15 mm or more and 1.5 mm or less, and particularly preferably 0.3 mm or more and 1.2 mm or less. As the thickness of first fiber reinforced resin 810 becomes larger, the strength of first fiber reinforced resin layer 110 is increased, and the strength of molded body 100 imparted by first fiber reinforced resin layer 110 is also increased. As the thickness of first fiber reinforced resin 810 becomes smaller, the moldability of first fiber reinforced resin 810 is improved, and molded body 100 having various shapes is easily prepared.

The thickness of first fiber reinforced resin 810 can be adjusted by the number of UD sheets to be laminated. At this time, the laminated UD sheets may be fused to each other in advance by thermal pressing or the like, or a plurality of UD sheets that are not fused to each other may be disposed inside mold 600.

The thickness of second fiber reinforced resin 820 is preferably larger than the thickness of first fiber reinforced resin 810. By making second fiber reinforced resin 820 thicker, even when the thickness of first fiber reinforced resin 810 is reduced to reduce the thickness of the molded body, second fiber reinforced resin layer 120 can be sufficiently formed after the inflow into rib portion 130, and the marble-like appearance of molded body 100 imparted by second fiber reinforced resin layer 120 can be clearly formed. On the other hand, the strength of rib portion 130 can be increased by making first fiber reinforced resin 810 thinner. The thickness of second fiber reinforced resin 820 may be smaller than the thickness of first fiber reinforced resin 810.

Specifically, the thickness of second fiber reinforced resin 820 is preferably 0.3 mm or more and 4 mm or less, more preferably 0.3 mm or more and 2.5 mm or less, still more preferably 0.4 mm or more and 2 mm or less, and particularly preferably 0.4 mm or more and 1.2 mm or less.

The thickness of second fiber reinforced resin 820 can be adjusted by the number of chopped sheets or the like. In the present embodiment, the chopped sheets may be fused to each other in advance by thermal pressing or the like to form a random sheet, and the random sheet may be disposed inside mold 600 (on first fiber reinforced resin 810), or a plurality of chopped sheets that are not fused to each other may be spread randomly on first fiber reinforced resin 810 to be disposed inside mold 600.

In the disposed second fiber reinforced resin 820, the mass of reinforcing fibers 822 per unit area is preferably 270 g/m² or more and 3,600 g/m² or less, more preferably 350 g/m² or more and 2,400 g/m² or less, and still more preferably 400 g/m² or more and 1,500 g/m² or less. As the mass of reinforcing fibers 122 per unit area becomes larger, a larger amount of the reinforcing fibers is more likely to fill rib portion 130, the strength of rib portion 130 is further increased, scratches, cracking, or the like is less likely to occur in rib portion 130 during the molding, and the appearance of rib portion 130 is further improved. As the mass of reinforcing fibers 122 per unit area becomes smaller, the generation of burrs on the surface of second fiber reinforced resin layer 120 is less likely to occur, and the appearance of molded body 100 (the appearance of the surface on second fiber reinforced resin layer 120 side) can be further improved.

### (Step S520: Molding of Fiber Reinforced Resin)

In the present step, first fiber reinforced resin 810 and second fiber reinforced resin 820 disposed inside mold 600 in the previous step are pressurized and molded inside mold 600.

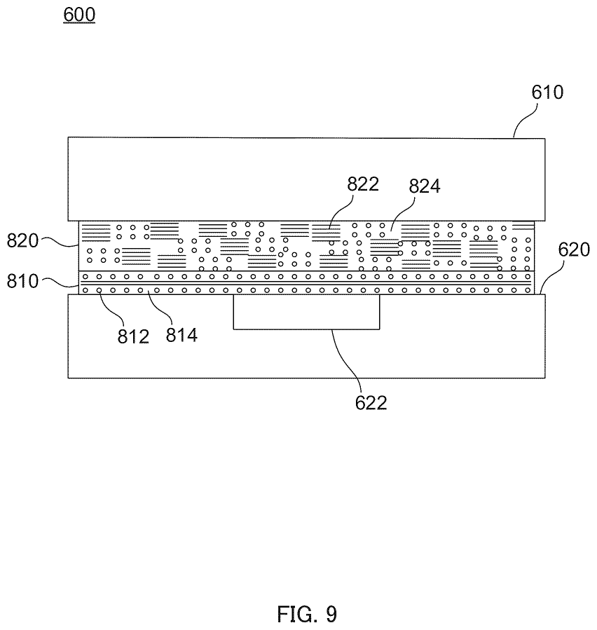

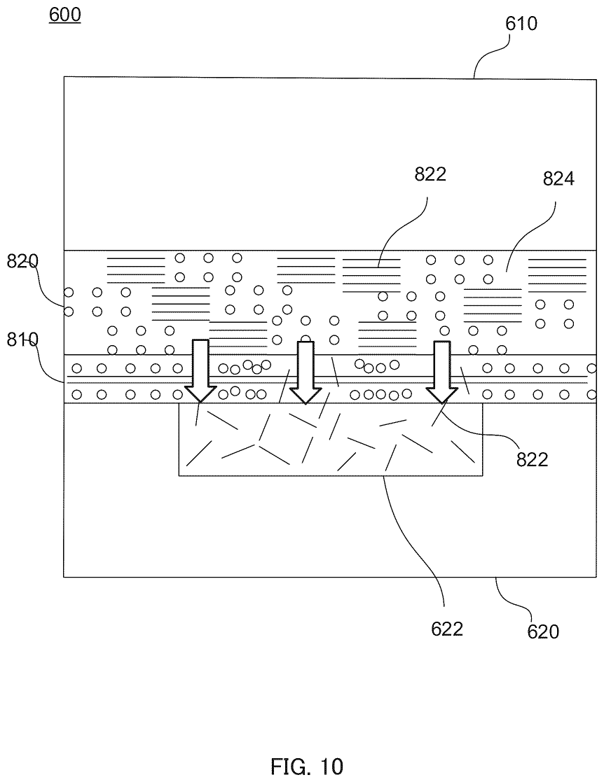

FIGS. 9 and 10 are schematic cross-sectional views of mold 600 illustrating a state in which first fiber reinforced resin 810 and second fiber reinforced resin 820 are molded in the present step, where the cross sections are the same as those in FIGS. 7A and 7B. In the present step, mold clamping is performed, the inside of mold 600 is heated by a heating unit (not illustrated), and core mold 610 and cavity mold 620 are pressed in a direction in which they approach each other to apply pressure to the inside of mold 600 (see FIG. 9).

Matrix resin 814 included in first fiber reinforced resin 810 and matrix resin 824 included in second fiber reinforced resin 820 are melted by the above-described heating. At this time, reinforcing fibers 812 included in first fiber reinforced resin 810 are long fibers and thus do not move so much, but reinforcing fibers 822 included in second fiber reinforced resin 820 are shorter and more movable. When the melted matrix resin 824 flows into cavity section 622 by the applied pressure, reinforcing fibers 822 (which are relatively movable) also flow into cavity section 622 together with the melted matrix resin 824. At this time, reinforcing fibers 822 flow into cavity section 622 while spreading the spaces between the fibers of reinforcing fibers 812 included in first fiber reinforced resin 810. As a result, a part of reinforcing fibers 812 is partially bent and the alignment is partially displaced at a portion corresponding to cavity section 622 (see FIG. 4).

As a result, reinforcing fibers 822 flow into cavity section 622 together with matrix resin 824 (and matrix resin 814) (see FIG. 10). Since reinforcing fibers 822 are hardly cut during the inflow, reinforcing fibers 822 maintain substantially the same length as the length when reinforcing fibers 822 were located in second fiber reinforced resin 820.

On the other hand, when the rib portion is to be formed by injection, the reinforcing fibers are cut by a pressure during flowing inside an injection machine or during the injection, and therefore it is difficult to fill rib portion 130 with long reinforcing fibers. According to the findings of the present inventors, the fiber length of the reinforcing fibers that can fill rib portion 130 in a case of injection is at most about 2.5 mm. On the other hand, in the present embodiment, since rib portion 130 is formed without performing injection, the reinforcing fibers are less likely to be cut, and rib portion 130 is more likely to be filled with long reinforcing fibers. Therefore, rib portion 130 having a sufficient height can be formed and the strength of rib portion 130 can be sufficiently increased.

According to the findings of the present inventors, when second fiber reinforced resin 820 including relatively short reinforcing fibers is disposed in mold 600 and molded, it is difficult to form rib portion 130 having a sufficient height. The reason therefor is considered as follows: during the molding, reinforcing fibers 822 and matrix resin 824 of second fiber reinforced resin 820 are more likely to flow in the in-plane direction and are less likely to move in the thickness direction (toward the inside of cavity section 622), and thus rib portion 130 having a sufficient height is less likely to be formed when only second fiber reinforced resin 820 is used. On the other hand, when first fiber reinforced resin 810 is disposed on the rib portion 130 side (cavity section 622 side) of second fiber reinforced resin 820, it is considered that the movement of reinforcing fibers 822 and matrix resin 824 in the in-plane direction is suppressed by shear resistance of reinforcing fibers 812 of first fiber reinforced resin 810, while the movement of reinforcing fibers 822 and matrix resin 824 in the thickness direction through the spaces between reinforcing fibers 812 is promoted, and thus rib portion 130 having a sufficient height is more likely to be formed.

In addition, when only first fiber reinforced resin 810 is disposed in mold 600 and molded, it is also difficult to form rib portion 130 having a sufficient height. The reason therefor is considered as follows: first fiber reinforced resin 810 includes reinforcing fibers 812, which are long fibers, and thus has low moldability.

In addition, when second fiber reinforced resin 820 is disposed on the rib portion 130 side (cavity section 622 side) of first fiber reinforced resin 810, it is also difficult to form rib portion 130 having a sufficient height. The reason therefor is considered as follows: unlike the aspect of the present embodiment, the movement of reinforcing fibers 812 in the thickness direction through the spaces between the fibers is not promoted.

The heating temperature in the present step may be a temperature at which matrix resin 814 of first fiber reinforced resin 810 and matrix resin 824 of second fiber reinforced resin 820 are melted. When the matrix resins are a thermoplastic resin or thermoplastic resins, the heating temperature may be a temperature at which the thermoplastic resin is melted and can be set to be equal to or higher than the melting point of the matrix resin and equal to or lower than a temperature that is 50° C. higher than the melting point. When the matrix resins are a thermosetting resin or thermosetting resins, the temperature of the heating may be a temperature at which the thermosetting resin is cured, and can be set to be equal to or higher than a curing temperature of the matrix resin and equal to or lower than a temperature that is 50° C. higher than the curing temperature. The above-described melting point of the matrix resin means the higher of the melting point of matrix resin 814 of first fiber reinforced resin 810 and the melting point of matrix resin 824 of second fiber reinforced resin 820. In addition, the above-described curing temperature of the matrix resin means the higher of the curing temperature of matrix resin 814 of first fiber reinforced resin 810 and the curing temperature of matrix resin 824 of second fiber reinforced resin 820. The above-described pressure can be set to 0.5 MPa or more and 20 MPa or less. However, a method for applying pressure is not limited to the press molding method using a press molding machine. Examples of other pressurization methods include a press molding method using a double belt press machine and an autoclave method using an autoclave device.

### OTHER EMBODIMENTS

The above-described embodiments are exemplary embodiments of the present invention, and it goes without saying that the present invention can include implementations other than the above-described embodiments within the scope of the core technical idea of the present invention.

For example, the molded body may include a layer having a configuration different from those of the above-described layers between the rib portion and the first fiber reinforced resin layer and between the first fiber reinforced resin layer and the second fiber reinforced resin layer. Such a layer is preferably a layer that is less likely to inhibit the flow of the reinforcing fibers into the rib portion, and examples thereof include various resin layers such as a resin layer not including reinforcing fibers and a resin layer including reinforcing fibers that are short fibers.

In addition, the molded body may include a layer having a configuration different from those of the above-described layers outside the rib portion, at a portion of the first fiber reinforced resin layer where the rib portion is not provided, or outside the second fiber reinforced resin layer.

In addition, in the above-described embodiment, an implementation has been described in which first fiber reinforced resin 810 and second fiber reinforced resin 820 are heated inside mold 600, but first fiber reinforced resin 810 and second fiber reinforced resin 820 may be heated to a temperature equal to or higher than the melting point outside mold 600 and then disposed in mold 600. That is, first fiber reinforced resin 810 and second fiber reinforced resin 820 may be heated before step S510 and step S520.

In addition, in the above-described embodiment, the molded body includes only one rib portion, but the molded body may include a plurality of rib portions. The plurality of rib portions may extend in the same direction or in different directions. In addition, the plurality of rib portions may be disposed to intersect with each other. In addition, when the molded body bas a wall portion at a peripheral edge portion of the first fiber reinforced resin layer, an end portion of the rib portion may be in contact with the wall portion.

In addition, the above-described method for producing a molded body is not limited to a producing method including only these steps, the method may include another step as long as a desired molded body is produced.

### Application

The applications of the above-described molded body of a fiber reinforced resin are not limited, but the molded body is useful as a load absorbing material in applications in which a load is applied from a predetermined direction after the molded body is formed to have a three-dimensional shape. In addition, when rib portion 130 is to be fitted into another member to be assembled with the other member, the above-described molded body of a fiber reinforced resin has high durability because the strength of the rib portion is high.

### EXAMPLES

The present invention will be described in detail based on Examples, but the present invention is not limited to these Examples.

### 1. Preparation of Fiber Reinforced Resin

### 1-1. UD Sheet (First Fiber Reinforced Resin)

A UD sheet (manufactured by Mitsui Chemicals, Inc., TAFNEX) was used as a first fiber reinforced resin. The UD sheet was a UD sheet containing polypropylene and carbon fibers, and had a fiber volume fraction (Vf) of 50% by volume and a thickness of 0.15 mm. The melting point of the polypropylene measured by a DSC method according to JIS K 7121 was 168° C., and the melt flow rate (MFR) of the polypropylene measured according to ASTM D-1238 at 230° C. under a load of 2,160 g was 200.0 g/10 min.

### 1-2. Random Sheet (Second Fiber Reinforced Resin)

### 1-2-1. Preparation of Random Sheet 1

The above-described UD sheet was cut such that a length in a direction orthogonal to the alignment direction of reinforcing fibers was 12.5 mm, and then cut using a tape cutter H510 manufactured by Hashima Co., Ltd. such that a length in a direction along the alignment direction of the reinforcing fibers was 3.0 mm, thereby obtaining chopped sheets. Next, 50.3 g of the chopped sheets was spread in a mold having a length of 220 mm and a width of 220 mm so that the fiber direction was random. Using a mini test press machine manufactured by Toyo Seiki Seisaku-sho, Ltd., the spread chopped sheet was preheated at a temperature of 175° C. and a pressure of 3 MPa for 8 minutes, bumped 5 times at 175° C. and a pressure of 10 MPa, pressurized at 175° C. and a pressure of 10 MPa for 2 minutes, and cooled at 15° C. and a pressure of 10 MPa for 3 minutes, thereby obtaining random sheet 1.

### 1-2-2. Preparation of Random Sheet 2

Random sheet 2 was obtained in the same manner as in the preparation of random sheet 1, except that the length of the random sheet in the direction along the alignment direction of the reinforcing fibers was changed to 9.0 mm.

### 1-2-3. Preparation of Random Sheet 3

Random sheet 3 was obtained in the same manner as in the preparation of random sheet 1, except that the length of the random sheet in the direction along the alignment direction of the reinforcing fibers was changed to 15.0 mm.

### 1-2-4. Preparation of Random Sheet 4

Random sheet 4 was obtained in the same manner as in the preparation of random sheet 1, except that the length of the random sheet in the direction along the alignment direction of the reinforcing fibers was changed to 30.0 mm.

### 1-2-5. Preparation of Random Sheet 5

Random sheet 5 was obtained in the same manner as in the preparation of random sheet 3, except that the amount of the chopped sheet spread in the mold was changed to 62.9 g.

### 1-2-6. Preparation of Random Sheet 6

Random sheet 6 was obtained in the same manner as in the preparation of random sheet 3, except that the amount of the chopped sheet spread in the mold was changed to 37.8 g.

### 1-2-7. Preparation of Random Sheet 7

Random sheet 7 was obtained in the same manner as in the preparation of random sheet 1, except that the length of the random sheet in the direction along the alignment direction of the reinforcing fibers was changed to 55.0 mm.

### 2. Preparation of Molded Body

### 2-1. Preparation of Molded Body 1 (Example 1)

### 2-1-1. Preparation of Laminate 1

Two UD sheets were disposed on a surface of random sheet 1 such that an angle formed by the alignment directions of the reinforcing fibers of the UD sheets was 90° (0°/90°). Using a mini test press machine manufactured by Toyo Seiki Seisaku-sho, Ltd., the random sheet and UD sheet were preheated at a temperature of 175° C. and a pressure of 3 MPa for 8 minutes, bumped 5 times at a temperature of 175° C. and a pressure of 10 MPa, pressurized at a temperature of 175° C. and a pressure of 10 MPa for 2 minutes, and cooled at 15° C. and a pressure of 10 MPa for 3 minutes, thereby obtaining laminate 1.

### 2-1-2. Forming

Laminate 1 was disposed in the mold illustrated in FIGS. 6 to 7B such that the UD sheet side of the laminate was on the rib side and the random sheet side of the laminate was on the side opposite to the rib. At this time, laminate 1 was disposed such that a direction (0° direction) in which the reinforcing fibers of a UD sheet (which is in contact with the random sheet and among the two UD sheets) were aligned coincides with the longitudinal direction of the rib of the mold (that is, the directions in which the reinforcing fibers of the two UD sheets were aligned were 0° and 90° in this order from the random sheet side, with respect to the longitudinal direction of the rib). Laminate 1 was heated at 240° C. for 2 minutes using a DH832 oven manufactured by Yamato Scientific Co., Ltd., and then pressurized at a mold temperature of 145° C. and a pressure of 5 MPa for 1 minute using a 250 t press processing machine manufactured by Ogihara Producing Co., Ltd., and cooled to a mold temperature of 90° C. at a cooling rate of 17° C./min while the pressurization was maintained, thereby obtaining a formed article (molded body 1).

As the mold, the following was used: a mold whose molding surface has a size of 220 mm in the vertical direction (longitudinal direction of the rib portion, L1 in FIGS. 6) and 220 mm in the horizontal direction (width direction of the rib portion, L2 in FIG. 6); and a cavity section of the mold for forming the rib portion has a shape such that the length (L3 in FIG. 7A) of the rib portion was 20 mm and the length (L4 in FIG. 7A) of the root portion of the rib portion was 22 mm in the length direction of the rib portion, the width (L5 in FIG. 7B) of the rib portion was 2 mm and the width (L6 in FIG. 7B) of the root portion of the rib portion was 4 mm in the width direction of the rib portion, and the height (L7 in FIG. 7A and FIG. 7B) of the rib portion was 15 mm.

### 2-2. Preparation of Molded Bodies 2 to 4 (Examples 2 to 4)

Laminate 2 to laminate 4 were obtained in the same manner as in the preparation of molded body 1 to obtain molded bodies 2 to 4, except that random sheets 2 to 4 were used instead of random sheet 1.

### 2-3. Preparation of Molded Bodies 5 and 6 (Examples 5 and 6)

Molded body 5 was obtained in the same manner as in the preparation of molded body 3, except that laminate 3 was disposed in the mold such that the direction (0° direction) in which the reinforcing fibers of the UD sheet in contact with the random sheet were aligned was 45° with respect to the longitudinal direction of the rib of the mold (the directions in which the reinforcing fibers of the two UD sheets were aligned were 45° and −45° in this order from the random sheet side, with respect to the longitudinal direction of the rib).

Molded body 6 was obtained in the same manner as in the preparation of molded body 3, except that laminate 3 was disposed in the mold such that the direction (0° direction) in which the reinforcing fibers of the UD sheet in contact with the random sheet were aligned was 90° with respect to the longitudinal direction of the rib of the mold (the directions in which the reinforcing fibers of the two UD sheets were aligned were 90° and 0° in this order from the random sheet side, with respect to the longitudinal direction of the rib).

### 2-4. Preparation of Molded Body 7 (Example 7)

### 2-4-1. Preparation of Laminate 7

Four UD sheets were disposed on a surface of random sheet 3 such that the angles formed by the alignment directions of the reinforcing fibers of the UD sheets were all 90° between the layers (0°/90°/0°/90°). Except for the above configuration, laminate 7 was obtained in the same manner as in the preparation of laminate 1.

### 2-4-2. Forming

Laminate 7 was disposed in the mold illustrated in FIGS. 6 to 7B such that the UD sheet side of the laminate was on the rib side and the random sheet side of the laminate was on the side opposite to the rib. At this time, laminate 7 was disposed such that the direction (0° direction) in which the reinforcing fibers of a UD sheet (which is in contact with the random sheet and among the four UD sheets) were aligned coincides with the longitudinal direction of the rib of the mold (that is, the directions in which the reinforcing fibers of the four UD sheets were aligned were 0°, 90°, 0°, and 90° in this order from the random sheet side, with respect to the longitudinal direction of the rib). Except for the above configuration, molded body 7 was obtained in the same manner as in the preparation of molded body 1.

### 2-5. Preparation of Molded Body 8 (Example 8)

### 2-5-1. Preparation of Laminate 8

Eight UD sheets were disposed on a surface of random sheet 3 such that the angles formed by the alignment directions of the reinforcing fibers of the UD sheets were all 90° between the layers (0°/90°/0°/90°/0°/90°/0°/90°). Except for the above configuration, laminate 8 was obtained in the same manner as in the preparation of laminate 1.

### 2-5-2. Forming

Laminate 8 was disposed in the mold illustrated in FIGS. 6 to 7B such that the UD sheet side of the laminate was on the rib side and the random sheet side of the laminate was on the side opposite to the rib. At this time, laminate 8 was disposed such that the direction (0° direction) in which the reinforcing fibers of a UD sheet (which is in contact with the random sheet and among the eight UD sheets) were aligned coincides with the longitudinal direction of the rib of the mold (that is, the directions in which the reinforcing fibers of the eight UD sheets were aligned were 0°, 90°, 0°, 90°, 0°, 90°, 0°, and 90° in this order from the random sheet side, with respect to the longitudinal direction of the rib). Except for the above configuration, molded body 8 was obtained in the same manner as in the preparation of molded body 1.

### 2-6. Preparation of Molded Bodies 9 and 10 (Examples 9 and 10)

Laminate 9 and laminate 10 were obtained in the same manner as in the preparation of molded body 1, except that random sheets 5 and 6 were respectively used instead of random sheet 1, and molded bodies 9 and 10 were obtained.

### 2-7. Preparation of Molded Body 11 (Comparative Example 1)

### 2-7-1. Preparation of Laminate 11

Two UD sheets were disposed on a surface of random sheet 3 such that the angle formed by the alignment directions of the reinforcing fibers of the UD sheets was 90° (at 0°/90°), and random sheet 3 was further disposed on the surface of a UD sheet. Except for the above configuration, laminate 11 was obtained in the same manner as in the preparation of laminate 1.

### 2-7-2. Forming

Laminate 11 was disposed in the mold illustrated in FIGS. 6 to 7B. At this time, laminate 11 was disposed such that the direction (0° direction) in which the reinforcing fibers of a UD sheet (which is on the rib side and among the two UD sheets) were aligned coincides with the longitudinal direction of the rib of the mold (that is, the directions in which the reinforcing fibers of the two UD sheets were aligned were 0° and 90° in this order from the side opposite to the rib, with respect to the longitudinal direction of the rib). Except for the above configuration, molded body 11 was obtained in the same manner as in the preparation of molded body 1.

### 2-8. Preparation of Molded Body 12 (Comparative Example 2)

Laminate 3 was disposed in the mold illustrated in FIGS. 6 to 7B such that the random sheet side of the laminate was on the rib side and the UD sheet side of the laminate was on the side opposite to the rib. At this time, laminate 3 was disposed such that the direction (0° direction) in which the reinforcing fibers of a UD sheet (which is on the rib side and among the two UD sheets) were aligned coincides with the longitudinal direction of the rib of the mold (that is, the directions in which the reinforcing fibers of the two UD sheets were aligned were 0° and 90° in this order from the side opposite to the rib, with respect to the longitudinal direction of the rib). Except for the above configuration, molded body 12 was obtained in the same manner as in the preparation of molded body 1.

### 2-9. Preparation of Molded Body 13 (Comparative Example 3)

### 2-9-1. Preparation of Laminate 13

Six UD sheets were disposed such that the angles formed by the alignment directions of the reinforcing fibers of the UD sheets were all 90° between the layers (0°/90°/0°/90°/0°/90°). Except for the above configuration, laminate 13 was obtained in the same manner as in the preparation of laminate 1.

### 2-9-2. Forming

Laminate 13 was disposed in the mold illustrated in FIGS. 6 to 7B. At this time, laminate 13 was disposed such that the direction (0° direction) in which the reinforcing fibers of a UD sheet (which is closest to the rib and among the six UD sheets) were aligned coincides with the longitudinal direction of the rib of the mold (that is, the directions in which the reinforcing fibers of the six UD sheets were aligned were 0°, 90°, 0°, 90°, 0°, and 90° in this order from the side opposite to the rib, with respect to the longitudinal direction of the rib). Except for the above configuration, molded body 13 was obtained in the same manner as in the preparation of molded body 1.

### 2-10. Preparation of Molded Body 14 (Comparative Example 4)

Random sheet 5 was disposed in the mold illustrated in FIGS. 6 to 7B. Except for the above configuration, molded body 14 was obtained in the same manner as in the preparation of molded body 1.

### 3. Evaluation

### 3-1. Height of Rib Portion

The height of the rib portion of each obtained molded body was visually measured using a ruler, and the height of the rib portion of each molded body was evaluated according to the following standard.
∘: The height of the rib portion was 15 mm
Δ: The height of the rib portion was 10 mm or more and less than 15 mm
x: The height of the rib portion was less than 10 mm

### 3-2. Fiber Length of Reinforcing Fiber in Rib Portion

The root portion (a portion from the lower end of 0 mm to 5 mm) of the rib portion was heated to 180° C. (a temperature equal to or higher than the melting point of polypropylene) with a soldering iron to melt the resin of the root portion, and the tip portion was pinched to remove the rib portion while being careful not to damage the rib portion. The removed rib portion was heated at 500° C. for 3 minutes to thermally decompose the resin, thereby obtaining only the reinforcing fibers. Randomly, 100 reinforcing fibers were selected from the obtained reinforcing fibers, the fiber lengths thereof were measured using an optical microscope, and an arithmetic mean value of the fiber lengths of the 100 fibers was used as the fiber length of the reinforcing fibers in the rib portion.

### 3-3. Vf of Rib Portion

The rib portion was cut off from the root using a reciprocating saw (EZ47A1PN2G manufactured by Panasonic Corporation) from the obtained molded body, and the total weight (g) of the rib portion was measured. Next, the weight was measured again after heating the rib portion at 500° C. for 30 minutes using a muffle furnace (FC300 manufactured by Yamato Scientific Co., Ltd.) to thermally decompose the resin, and the fiber content (g) in the rib was calculated. The resin content (g) was also calculated assuming that only the resin component was contained other than the reinforcing fibers, and Vf was obtained by setting the density of the reinforcing fibers to 1.8 g/cm³ and the density of the resin component to 0.9 g/cm³.

### 3-4. Appearance of Rib Portion

The appearance of the rib portion was visually observed for the rib portion whose height evaluation was “∘”, and the appearance of the rib portion of each molded body was evaluated according to the following standard based on the presence or absence of scratches.
⊚: There were no scratches on the rib portion
∘: Scratches having a length of less than 2 mm were confirmed on the rib portion
Δ: Scratches having a length of 2 mm or more and less than 5 mm were confirmed on the rib portion
x: Scratches having a length of 5 mm or more were confirmed on the rib portion

### 3-5. Breaking Load of Rib Portion

For the rib portion whose height evaluation was “∘”, the molded body was cut out into a size of a width of 80 mm and a length of 80 mm with the rib portion at the center. Portions 20 mm from both end parts of the cut molded body in a direction orthogonal to the longitudinal direction of the rib portion were fixed, and a compressive load was applied at a speed of 2 mm/min to a range of a width of 5 mm and a length of 5 mm at the upper end of the central portion of the rib portion in the longitudinal direction. The load applied from the start of loading until the load dropped was used as the breaking load of the rib portion. STRONGRAPH VE55D manufactured by Toyo Seiki Seisaku-sho, Ltd. was used for the evaluation of the breaking load.

Based on the obtained values of the breaking load, the breaking load of the rib portion of each molded body was evaluated according to the following standard.
⊚: The breaking load was 420 N or more
∘: The breaking load was 300 N or more and less than 420 N
Δ: The breaking load was 180 N or more and less than 300 N
x: The breaking load was less than 180 N

### 3-6. Appearance of Molded Body

The appearance of each molded body was evaluated according to the following standard by visually observing the surface of the molded body on the side opposite to the side where the rib portion was formed.
∘: The surface had a marble-like appearance
x: The surface did not have a marble-like appearance

The layer configurations of molded bodies 1 to 14 (the lamination order of the materials used for preparation, the fiber length in the random sheet, the thickness of the random sheet, the mass of the reinforcing fibers included in the random sheet per unit area, and the thickness of the UD sheet), and the results of the above-described evaluations are shown in Tables 1 to 3. In Tables 1 to 3, “RC” indicates a random sheet and “UDS” indicates a UD sheet. In addition, the alignment angles of the second layer described in Tables 1 to 3 indicate the angles formed by the alignment directions of the reinforcing fibers of the plurality of UD sheets constituting the second layer with respect to the longitudinal direction of the rib, and indicate that the UD sheets are laminated in an order such that the upper side in the table is the side opposite to the rib, the lower side in the table is the rib side, and the angle formed by the reinforcing fibers of each UD sheet is the angle described in the table.

TABLE 1

| Remarks | | | Example | Example | Example | Example |
|---|---|---|---|---|---|---|
| Molded body No. | | | 1 | 2 | 3 | 4 |
| ↑ | First | Type | RC 1 | RC 2 | RC 3 | RC 4 |
| (Opposite side | layer | Fiber length | 3 | 9 | 15 | 30 |
| of rib portion) | | (mm) | | | | |
| | | Thickness | 0.8 | 0.8 | 0.8 | 0.8 |
| | | (mm) | | | | |
| | | Mass of fiber | 678 | 668 | 690 | 665 |
| | | (g/m²) | | | | |
| Layer | Second | Type | UDS | UDS | UDS | UDS |
| configuration | layer | | (two | (two | (two | (two |
| | | | layers) | layers) | layers) | layers) |
| | | Alignment | 0° | 0° | 0° | 0° |
| | | angle | 90° | 90° | 90° | 90° |
| | | Thickness | 0.3 | 0.3 | 0.3 | 0.3 |
| | | (mm) | | | | |
| (Rib portion | Third | Type | — | — | — | — |
| side) | layer | Fiber length | | | | |
| ↓ | | (mm) | | | | |
| | | Thickness | | | | |
| | | (mm) | | | | |
| | | Mass of fiber | | | | |
| | | (g/m²) | | | | |

| | | | | | |
|---|---|---|---|---|---|
| Evaluation of | Height | ◯ | ◯ | ◯ | ◯ |
| rib portion | Fiber length | 3.0 | 8.8 | 14.4 | 29.7 |
| | (mm) | | | | |
| | Vf (%) | 48.1 | 47.4 | 49.0 | 47.2 |
| | Appearance | ◯ | ⊚ | ⊚ | ⊚ |
| | Breaking load | 193 | 273 | 347 | 475 |
| | (N) | | | | |
| | Breaking load | Δ | Δ | ◯ | ⊚ |

| | | | | |
|---|---|---|---|---|
| Evaluation of appearance of molded body | ◯ | ◯ | ◯ | ◯ |

TABLE 2

| Remarks | | | Example | Example | Example | Example | Example | Example |
|---|---|---|---|---|---|---|---|---|
| Molded body No. | | | 5 | 6 | 7 | 8 | 9 | 10 |
| ↑ | First | Type | RC 3 | RC 3 | RC 3 | RC 5 | RC 6 | RC 6 |
| (Opposite side | layer | Fiber length | 15 | 15 | 15 | 15 | 15 | 15 |
| of rib portion) | | (mm) | | | | | | |
| | | Thickness | 0.8 | 0.8 | 0.8 | 1.0 | 0.6 | 0.6 |
| | | (mm) | | | | | | |
| | | Mass of | 685 | 658 | 691 | 850 | 527 | 531 |
| | | fiber (g/m²) | | | | | | |
| Layer | Second | Type | UDS | UDS | UDS | UDS | UDS | UDS |
| configuration | layer | | (two | (two | (four | (eight | (two | (four |
| | | | layers) | layers) | layers) | layers) | layers) | layers) |
| | | Alignment | 45° | 90° | 0° | 0° | 0° | 0° |
| | | angle | −45° | 0° | 90° | 90° | 90° | 90° |
| | | | | | 0° | 0° | | 0° |
| | | | | | 90° | 90° | | 90° |
| | | | | | | 0° | | |
| | | | | | | 90° | | |
| | | Thickness | 0.3 | 0.3 | 0.6 | 1.2 | 0.3 | 0.6 |
| | | (mm) | | | | | | |
| (Rib portion | Third | Type | — | — | — | — | — | — |
| side) | layer | Fiber length | | | | | | |
| ↓ | | (mm) | | | | | | |
| | | Thickness | | | | | | |
| | | (mm) | | | | | | |
| | | Mass of | | | | | | |
| | | fiber (g/m²) | | | | | | |

| | | | | | | | |
|---|---|---|---|---|---|---|---|
| Evaluation of | Height | ◯ | ◯ | ◯ | ◯ | ◯ | ◯ |
| rib portion | Fiber length | 15.0 | 14.9 | 14.9 | 14.7 | 15.0 | 14.7 |
| | (mm) | | | | | | |
| | Vf (%) | 48.6 | 46.7 | 49.1 | 46.9 | 49.8 | 50.2 |
| | Appearance | ◯ | ⊚ | ⊚ | ◯ | ◯ | ◯ |
| | Breaking load | 400 | 309 | 310 | 252 | 321 | 269 |
| | (N) | | | | | | |
| | Breaking load | ◯ | ◯ | ◯ | Δ | ◯ | Δ |

| | | | | | | |
|---|---|---|---|---|---|---|
| Evaluation of appearance of | ◯ | ◯ | ◯ | ◯ | ◯ | ◯ |
| molded body | | | | | | |

TABLE 3

| | | | Comparative | Comparative | Comparative | Comparative |
|---|---|---|---|---|---|---|
| Remarks | | | Example | Example | Example | Example |
| Molded body No. | | | 11 | 12 | 13 | 14 |
| ↑ | First | Type | RC 3 | — | — | RC 5 |
| (Opposite | layer | Fiber length | 15 | | | 15 |
| side of rib | | (mm) | | | | |
| portion) | | Thickness | 0.8 | | | 1.0 |
| | | (mm) | | | | |
| | | Mass of fiber | 700 | | | 865 |
| | | (g/m²) | | | | |
| Layer | Second | Type | UDS | UDS | UDS | — |
| configuration | layer | | (two | (two | (six | |
| | | | layers) | layers) | layers) | |
| | | Alignment | 0° | 0° | 0° | |
| | | angle | 90° | 90° | 90° | |
| | | | | | 0° | |
| | | | | | 90° | |
| | | | | | 0° | |
| | | | | | 90° | |
| | | Thickness | 0.3 | 0.3 | 0.9 | |
| | | (mm) | | | | |
| (Rib portion | Third | Type | RC 3 | RC 3 | — | — |
| side) | layer | Fiber length | 15 | 15 | | |
| ↓ | | (mm) | | | | |
| | | Thickness | 0.8 | 0.8 | | |
| | | (mm) | | | | |
| | | Mass of fiber | 696 | 691 | | |
| | | (g/m²) | | | | |

| | | | | | |
|---|---|---|---|---|---|
| Evaluation | Height | Δ | Δ | X | X |
| of rib portion | Fiber length | 14.8 | Not | Not | Not |
| | (mm) | | measured | measured | measured |
| | Vf (%) | 49.7 | Not | Not | Not |
| | | | measured | measured | measured |
| | Appearance | Not | Not | Not | Not |
| | | evaluated | evaluated | evaluated | evaluated |
| | Breaking load | Unevaluable | Unevaluable | Unevaluable | Unevaluable |
| | (N) | | | | |
| | Breaking load | Unevaluable | Unevaluable | Unevaluable | Unevaluable |

| | | | | |
|---|---|---|---|---|
| Evaluation of appearance of | ◯ | X | X | ◯ |
| molded body | | | | |

As is clear from Tables 1 to 3, it was found that, a rib portion having a predetermined height can be formed and the cutting of the reinforcing fibers is almost never occurs with the configuration as follows: provided is a molded body including a first fiber reinforced resin layer that includes a plurality of reinforcing fibers arranged to be aligned in one direction and a matrix resin, and a second fiber reinforced resin layer that includes, disposed therein, blocks each including a plurality of reinforcing fibers arranged to be aligned in one direction and a matrix resin; and a rib portion including a plurality of reinforcing fibers and a matrix resin protrudes from the surface of the first fiber reinforced resin layer toward the side opposite to the second fiber reinforced resin layer.

The present application claims the priority of Japanese Patent Application No. 2023-020022 filed on Feb. 13, 2023. The specification, claims, and drawings of the present application are incorporated herein by reference.

### INDUSTRIAL APPLICABILITY

The molded body of a fiber reinforced resin according to the aspect of the present invention has a high strength of the rib portion, and thus the strength is increased. For this reason, the present invention is expected to contribute to the development of various fields related to fiber reinforced resin by exploring the possibility of utilizing fiber reinforced resin for more diverse applications.

### REFERENCE SIGNS LIST

100 Molded body of fiber reinforced resin
110 First fiber reinforced resin layer
112 Reinforcing fiber
112b Displaced portion
114 Matrix resin
120 Second fiber reinforced resin layer
122 Reinforcing fiber
124 Matrix resin
126 Block
130 Rib portion
132, 132a Reinforcing fiber
134 Matrix resin
600 Mold
610 Core mold
620 Cavity mold
622 Cavity section
810 First fiber reinforced resin
812 Reinforcing fiber
814 Matrix resin
820 Second fiber reinforced resin
822 Reinforcing fiber
824 Matrix resin
826 Block

1. A molded body of a fiber reinforced resin, the molded body comprising:
a first fiber reinforced resin layer including a plurality of reinforcing fibers arranged to be aligned in one direction and a matrix resin;
a second fiber reinforced resin layer including blocks each including a plurality of reinforcing fibers arranged to be aligned in one direction and a matrix resin, the blocks being randomly disposed; and
a rib portion including a plurality of reinforcing fibers and a matrix resin, the rib portion protruding from a surface of the first fiber reinforced resin layer toward a side opposite to the second fiber reinforced resin layer.

2. The molded body according to claim 1, wherein
the first fiber reinforced resin layer, the second fiber reinforced resin layer, and the rib portion are integrally molded.

3. The molded body according to claim 1, wherein
the first fiber reinforced resin layer includes, at a portion where the rib portion is formed, a displaced portion in which alignment of the plurality of arranged reinforcing fibers is displaced.

4. The molded body according to claim 1, wherein
an average fiber length of the plurality of reinforcing fibers included in the second fiber reinforced resin layer is substantially identical with an average fiber length of the plurality of reinforcing fibers included in the rib portion.

5. The molded body according to claim 1, wherein
one or some of the plurality of reinforcing fibers included in the rib portion are located across the rib portion and the first fiber reinforced resin layer.

6. The molded body according to claim 1, wherein
the rib portion has a height of 5 mm or more.

7. The molded body according to claim 1, wherein
the first fiber reinforced resin layer has a thickness of 40 μm or more and 3,000 μm or less.

8. The molded body according to claim 1, wherein
the second fiber reinforced resin layer has a thickness of 300 μm or more and 4,000 μm or less.

9. The molded body according to claim 1, wherein
the first fiber reinforced resin layer, the second fiber reinforced resin layer, and the rib portion all include a polyolefin resin as the matrix resin.

10. The molded body according to claim 1, wherein
the plurality of reinforcing fibers included in the second fiber reinforced resin layer have an average fiber length of 1 mm or more and 40 mm or less.

11. A method for producing a molded body of a fiber reinforced resin, the method comprising:
laminating and disposing, inside a mold, a first fiber reinforced resin and a second fiber reinforced resins, the first fiber reinforced resin including a plurality of reinforcing fibers arranged to be aligned in one direction and a matrix resin, the second fiber reinforced resins including blocks each including a plurality of reinforcing fibers arranged to be aligned in one direction and a matrix resin, the blocks each having a smaller size than that of the first fiber reinforced resin, the blocks being randomly aggregated; and
molding, inside the mold, the disposed first fiber reinforced resin and the disposed second fiber reinforced resins,
wherein
the mold includes a cavity section for molding a molded body in the molding, the molded body including a rib portion, and
in the disposing, the first fiber reinforced resin is disposed on the second fiber reinforced resins on a side of the cavity section.

12. The method according to claim 11, wherein
in the disposing, the second fiber reinforced resins are disposed inside the mold in such a way that a mass of the plurality of reinforcing fibers included in the second fiber reinforced resins is 270 g/m² or more and 3,600 g/m² or less per unit area.

13. The method according to claim 11, wherein
in the disposing, the first fiber reinforced resin having a thickness of 0.01 mm or more and 0.5 mm or less is disposed inside the mold.

14. The method according to claim 11, wherein
in the disposing, the second fiber reinforced resins in which an average fiber length of the plurality of reinforcing fibers is 1 mm or more and 40 mm or less are disposed inside the mold.
